(19) United States
(12) Patent Application Publication
(10) Pub. No.: US 2025/0108485 A1
(43) Pub. Date: Apr. 3, 2025

(54) System for assembling clamps

(71) Applicant: Contour Biosolutions, LLC, Middlesex, NJ (US)

(72) Inventor: Louis Bongiorno, Millington, NJ (US)

(73) Assignee: Contour Biosolutions, LLC, Middlesex, NJ (US)

(21) Appl. No.: 18/895,734

(22) Filed: Sep. 25, 2024

Related U.S. Application Data
(60) Provisional application No. 63/587,542, filed on Oct. 3, 2023.

(51) Int. Cl. B25B 5/00

(52) U.S. Cl. CPC B25B 5/003; B25B 5/006

(57) ABSTRACT

A system for assembling a clamp includes a first magazine, a plurality of first clamp sections, a second magazine, and a plurality of second clamp sections. The first magazine includes a first magazine channel while each first clamp section includes a first protrusion. The first clamp sections are arranged within the first magazine with each first protrusion positioned within the first magazine channel. The second magazine includes a second magazine channel while each second clamp section includes a second protrusion. The second clamp sections are arranged within the second magazine with each second protrusion positioned within the second magazine channel.

### CROSS REFERENCES AND PRIORITIES

This Application claims priority from U.S. Provisional Application No. 63/587,542 filed on 3 Oct. 2023, the teachings of which are incorporated by reference herein in their entirety.

### BACKGROUND

Chemical manufacturing, particularly pharmaceutical manufacturing, often requires aseptic sealing of the vessel within which the manufacturing process occurs and within the lines and conduits connected to said vessel. Aseptic sealing in such manufacturing typically requires the aseptic seal to withstand the pressures associated with the manufacturing process without leaking, breaking, or rupturing. A number of clamps, valves, connectors, and other fasteners have been developed to provide aseptic sealing of chemical manufacturing equipment in pressurized environments.

Recently, many chemical manufacturing processes have transitioned to single-use processing equipment as opposed to reusable processing systems which require stringent sterilization regimes using harsh chemicals and high temperature steam after each use. Single-use systems conduct the entire duration of the production process in a single batch, utilizing processing equipment that is transported off-site for sterilization using gamma, EtO, or x-ray sterilization methods. These methods provide greater assurance of sterility at a lower cost than steam sterilizing multi-use metal systems. The requirement of replacing the entire process assembly creates a need for products that assemble quickly and accurately.

Single-use processing equipment—in which the various components are typically manufactured of a polymer material as opposed to metals found in reusable processing systems—suffers from several flaws when compared to reusable processing systems. Most notably, an entire processing system must be assembled for each production batch. This process is time consuming and labor intensive—often conducted by hand by several individuals operating in a clean-room environment.

The need exist, therefore, for improved equipment for assembling single-use aseptic pressurized chemical manufacturing systems which can be assembled quickly and easily by hand.

### SUMMARY

A system for assembling a clamp is disclosed. The system may comprise a first magazine, a plurality of first clamp sections, a second magazine, and a plurality of second clamp sections. The first magazine may comprise a first magazine channel spanning at least a portion of a first length of the first magazine. Each first clamp section of the plurality of first clamp sections may have a first protrusion extending from a first sidewall of a first engagement member. The second magazine may comprise a second magazine channel spanning at least a portion of a second length of the second magazine. Each second clamp section of the plurality of second clamp sections may have a second protrusion extending from a second sidewall of a second engagement member. The first clamp sections may be arranged within the first magazine with each first protrusion positioned within the first magazine channel. The second clamp sections may be arranged within the second magazine with each second protrusion positioned within the second magazine channel.

In some embodiments, the first magazine channel may comprise a first channel sidewall having a first tongue extending therefrom, a first channel second sidewall having a second tongue extending therefrom, and a first channel bottom wall. In such embodiments, the first protrusion may comprise a first protrusion first sidewall having a first groove, a first protrusion second sidewall having a second groove, and a first protrusion bottom wall. The first tongue may be configured to engage the first groove, and the second tongue may be configured to engage the second groove.

In certain embodiments, the first magazine channel may comprise a first channel first sidewall having a first track, a first channel second sidewall having a second track, and a first channel bottom wall. In such embodiments, the first protrusion may comprise a first protrusion first sidewall having a first lip, a first protrusion second sidewall having a second lip, and a first protrusion bottom wall. The first lip may be configured to engage the first track, and the second lip may be configured to engage the second track.

In some embodiments, the second magazine channel may comprise a second channel first sidewall having a third tongue extending therefrom, a second channel second sidewall having a fourth tongue extending therefrom, and a second channel bottom wall. In such embodiments, the second protrusion may comprise a second protrusion first sidewall having a third groove, a second protrusion second sidewall having a fourth groove, and a second protrusion bottom wall. The third tongue may be configured to engage the third groove, and the fourth tongue may be configured to engage the fourth groove.

In certain embodiments, the second magazine channel may comprise a second channel first sidewall having a third track, a second channel second sidewall having a fourth track, and a second channel bottom wall. In such embodiments, the second protrusion may comprise a second protrusion first sidewall having a third lip, a second protrusion second sidewall having a fourth lip, and a second protrusion bottom wall. The third lip may be configured to engage the third track, and the fourth lip may be configured to engage the fourth track.

In some embodiments, the first magazine channel may span the entire first length. In certain embodiments the second magazine channel may span the entire second length. In some embodiments, each first clamp section and each second clamp section may be a toothed clamp section.

In certain embodiments, the plurality of first clamp sections may comprise a number of first clamp sections in a range of between 2 and 100. In some embodiments, the plurality of second clamp sections may comprise a number of second clamp sections in a range of between 2 and 100.

In some embodiments, each first clamp section of the plurality of first clamp sections may comprise a first top surface which at least partially conforms to a first inner surface of each other first clamp section of the plurality of first clamp sections. In such embodiments, at least one of the first clamp sections of the plurality of first clamp sections may be at least partially nested within another first clamp section of the plurality of first clamp sections.

In certain embodiments, each clamp section of the plurality of second clamp sections may comprise a second top surface which at least partially conforms to a second inner surface of each other second clamp section of the plurality of second clamp sections. In such embodiments, at least one of the second clamp sections of the plurality of second clamp sections may be at least partially nested within another second clamp section of the plurality of second clamp sections.

Also disclosed herein is a system for assembling a clamp comprising a third magazine, a plurality of third clamp sections, a fourth magazine, and a plurality of fourth clamp sections. The third magazine may comprise at least a third magazine first sidewall and a third magazine second sidewall forming a third magazine hollow interior which may comprise at least a first pair of guide members at a first end of the third magazine hollow interior and a second pair of guide members at a second end of the third magazine hollow interior. Each third clamp section of the plurality of third clamp sections may have at least a first pair of receiver members extending from a third engagement member and a second pair of receiver members extending from a fourth engagement member. The fourth magazine may comprise a fourth magazine back wall having at least a third pair of guide members extending from a third end of the third magazine back wall and a fourth pair of guide members extending from a fourth end of the fourth magazine back wall. Each fourth clamp section of the plurality of fourth clamp sections may have at least a third pair of receiver members extending from a fifth engagement member and a fourth pair of receiver members extending from a sixth engagement member. The third clamp sections may be arranged within the third magazine with the first pair of guide members engaged with the first pair of receiver members and the second pair of guide members engaged with the second pair of receiver members. The fourth clamp sections may be arranged within the fourth magazine with the third pair of guide members engaged with the third pair of receiver members and the fourth pair of guide members engaged with the fourth pair of receiver members.

In some embodiments, the third magazine may comprise a fifth pair of guide members between the first pair of guide members and the second pair of guide members. In such embodiments, each third clamp section may comprise a fifth pair of receiver members extending from the third engagement member between the first pair of receiver members and the second pair of receiver members. The fifth pair of guide members may be engaged with the fifth pair of receiver members.

In certain embodiments, the third magazine may comprise a sixth pair of guide members between the second pair of guide members and the first pair of guide members. In such embodiments, each third clamp section may comprise a sixth pair of receiver members extending from the fourth engagement member between the second pair of receiver members and the first pair of receiver members. The sixth pair of guide members may be engaged with the sixth pair of receiver members.

In some embodiments, the fourth magazine may comprise a seventh pair of guide members between the third pair of guide members and the fourth pair of guide members. In such embodiments, each fourth clamp section may comprise a seventh pair of receiver members extending from the fifth engagement member between the third pair of receiver members and the fourth pair of receiver members. The seventh pair of guide members may be engaged with the seventh pair of receiver members.

In certain embodiments, the fourth magazine may comprise an eighth pair of guide members between the fourth pair of guide members and the third pair of guide members. In such embodiments, each fourth clamp section may comprise an eighth pair of receiver members extending from the sixth engagement member between the fourth pair of receiver members and the third pair of receiver members. The eighth pair of guide members may be engaged with the eighth pair of receiver members.

In some embodiments, the third magazine first sidewall may comprise a first access hole. In certain embodiments, the third magazine second sidewall may comprise a second access hole.

In some embodiments, the fourth magazine back wall may comprise a first indentation. In certain embodiments, the fourth magazine back wall may comprise a second indentation.

In certain embodiments, the third magazine may comprise a third magazine third sidewall spanning a distance between the third magazine first sidewall and the third magazine second sidewall at the first end of the third magazine hollow interior, and a third magazine fourth sidewall spanning a distance between the third magazine first sidewall and the third magazine second sidewall at the second end of the third magazine hollow interior. In some embodiments, each third clamp section and each fourth clamp section may be a toothed clamp section.

In some embodiments, the plurality of third clamp sections may comprise a number of third clamp sections in a range of between 2 and 100. In certain embodiments, the plurality of fourth clamp sections may comprise a number of fourth clamp sections in a range of between 2 and 100.

In certain embodiments, each clamp section of the plurality of third clamp sections may comprise a third top surface which at least partially conforms to a third inner surface of each other third clamp section of the plurality of third clamp sections. In such embodiments, at least one of the third clamp sections of the plurality of third clamp sections may be at least partially nested within another third clamp section of the plurality of third clamp sections.

In certain embodiments, each clamp section of the plurality of fourth clamp sections may comprise a fourth top surface which at least partially conforms to a fourth inner surface of each other fourth clamp section of the plurality of fourth clamp sections. In such embodiments, at least one of the fourth clamp sections of the plurality of fourth clamp sections may be at least partially nested within another fourth clamp section of the plurality of fourth clamp sections.

### BRIEF DESCRIPTION OF FIGURES

FIG. 1 is a perspective view of a system for assembling clamps.

FIG. 2 is an exploded perspective view of a system for assembling clamps.

FIG. 3 is a perspective view of a clamp section.

FIG. 4 is an end view of a magazine and clamp section.

FIG. 5 is a perspective view of a clamp section.

FIG. 6 is an end view of a magazine and clamp section.

FIG. 7 is a perspective view of one step in assembling clamps using the system.

FIG. 8 is a perspective view of a second step in assembling clamps using the system.

FIG. 9 is a perspective view of a third step in assembling clamps using the system.

FIG. 10 is a perspective view of an alternative system for assembling clamps.

FIG. 11 is an exploded perspective view of an alternative system for assembling clamps.

FIG. 12 is a perspective view of one step in assembling clamps using the alternative system.

FIG. 13 is a perspective view of a second step in assembling clamps using the alternative system.

FIG. 14 is a perspective view of a third step in assembling clamps using the alternative system.

### DETAILED DESCRIPTION

Disclosed herein are systems for assembling clamps. The systems are described below with reference to the Figures. As described herein, the following numbers refer to the following structures as noted in the Figures.
10 refers to a system.
100 refers to a clamp.
110 refers to a first clamp section.
111 refers to a first protrusion.
112 refers to a first sidewall.
113 refers to a first engagement member.
114 refers to a first protrusion first sidewall.
115 refers to a first groove.
116 refers to a first protrusion second sidewall.
117 refers to a second groove.
118 refers to a first lip.
119 refers to a second lip.
120 refers to a second clamp section.
121 refers to a second protrusion.
122 refers to a second sidewall.
123 refers to a second engagement member.
124 refers to a second protrusion first sidewall.
125 refers to a third groove.
126 refers to a second protrusion second sidewall.
127 refers to a fourth groove.
128 refers to a third lip.
129 refers to a fourth lip.
130 refers to a clamp top surface.
140 refers to a clamp inner surface.
150 refers to a third clamp section.
151 refers to a first pair of receiver members.
152 refers to a third engagement member.
153 refers to a second pair of receiver members.
154 refers to a fourth engagement member.
155 refers to a fifth pair of receiver members.
156 refers to a sixth pair of receiver members.
160 refers to a fourth clamp section.
161 refers to a third pair of receiver members.
162 refers to a fifth engagement member.
163 refers to a fourth pair of receiver members.
164 refers to a sixth engagement member.
165 refers to a seventh pair of receiver members.
166 refers to an eighth pair of receiver members.
170 refers to a clamp top surface.
180 refers to a clamp inner surface.
200 refers to a first magazine.
210 refers to a first magazine channel.
211 refers to a first channel first sidewall.
212 refers to a first channel second sidewall.
213 refers to a first channel bottom wall.
214 refers to a first tongue.
215 refers to a second tongue.
216 refers to a first track.
217 refers to a second track.
220 refers to a first length.
300 refers to a second magazine.
310 refers to a second magazine channel.
311 refers to a second channel first sidewall.
312 refers to a second channel second sidewall.
313 refers to a second channel bottom wall.
314 refers to a third tongue.
315 refers to a fourth tongue.
316 refers to a third track.
317 refers to a fourth track.
320 refers to a second length.
400 refers to a first conduit section.
410 refers to a first conduit section first end.
412 refers to a flange.
500 refers to a second conduit section.
510 refers to a second conduit section first end.
512 refers to a flange.
600 refers to a third magazine.
610 refers to a third magazine first sidewall.
611 refers to a first access hole.
620 refers to a third magazine second sidewall.
621 refers to a second access hole.
630 refers to a third magazine hollow interior.
631 refers to a first end of the third magazine hollow interior.
632 refers to a second end of the third magazine hollow interior.
640 refers to a first pair of guide members.
650 refers to a second pair of guide members.
660 refers to a fifth pair of guide members.
670 refers to a sixth pair of guide members.
680 refers to a third magazine back wall.
690 refers to a third magazine third sidewall.
695 refers to a third magazine fourth sidewall.
700 refers to a fourth magazine.
710 refers to a fourth magazine back wall.
711 refers to a first indentation.
712 refers to a second indentation.
720 refers to a third pair of guide members.
730 refers to a fourth pair of guide members.
740 refers to a seventh pair of guide members.
750 refers to an eighth pair of guide members.

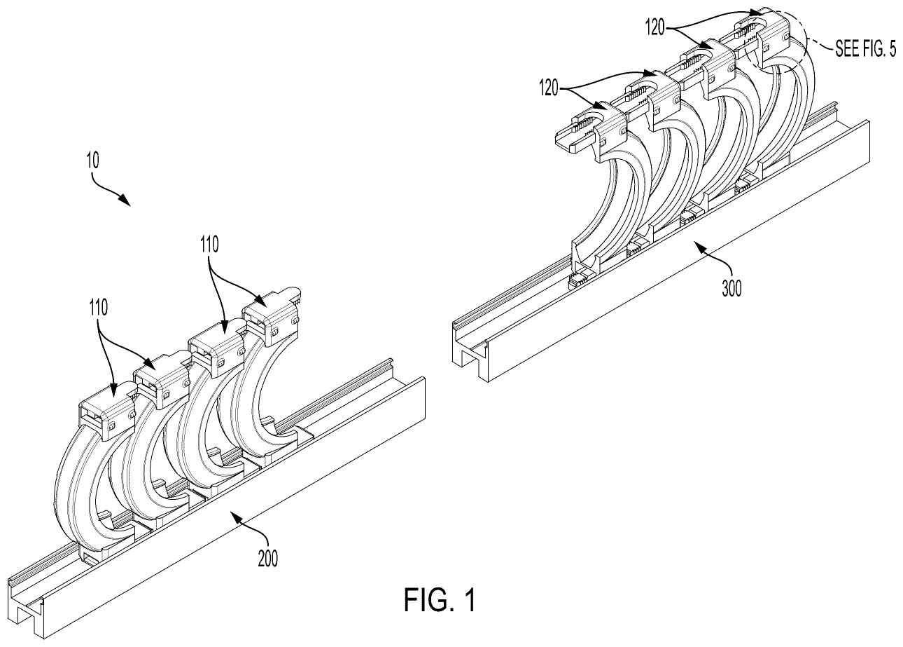

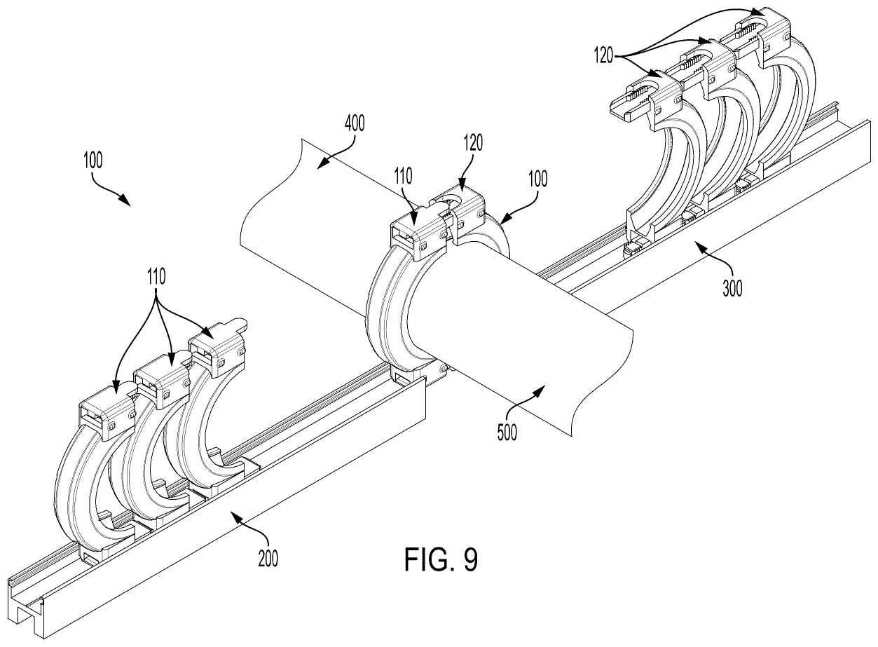

FIG. 1 shows a perspective view of a system (10) for assembling a clamp ((100) as shown in FIG. 9). As shown in FIG. 1, the system includes a first magazine (200) with a plurality of first clamp sections (110) and a second magazine (300) with a plurality of second clamp sections (120).

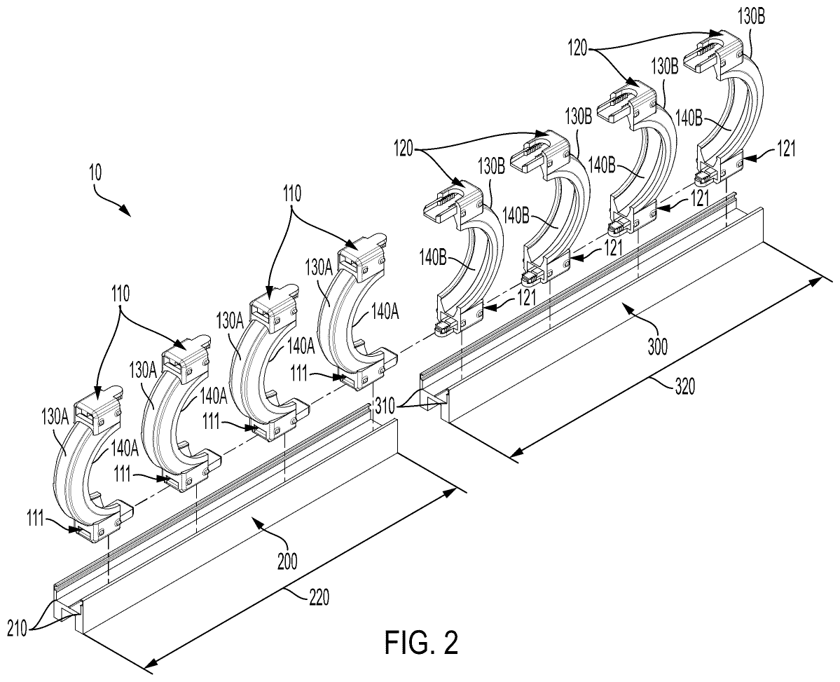

FIG. 2 is an exploded perspective view of the system (10) for assembling a clamp ((100) as shown in FIG. 9). As shown in FIG. 2, the first magazine (200) comprises a first magazine channel (210) spanning at least a portion of a first length (220) of the first magazine. The first magazine channel may span the entire first length. This first magazine channel is formed into what is considered the top surface of the first magazine as shown in FIG. 2.

The second magazine (300) may be of similar or identical construction to the first magazine (200). That is to say that the second magazine comprises a second magazine channel (310) spanning at least a portion of a second length (320) of the second magazine. The second magazine channel may span the entire second length. This second magazine channel is formed into what is considered the top surface of the second magazine as shown in FIG. 2.

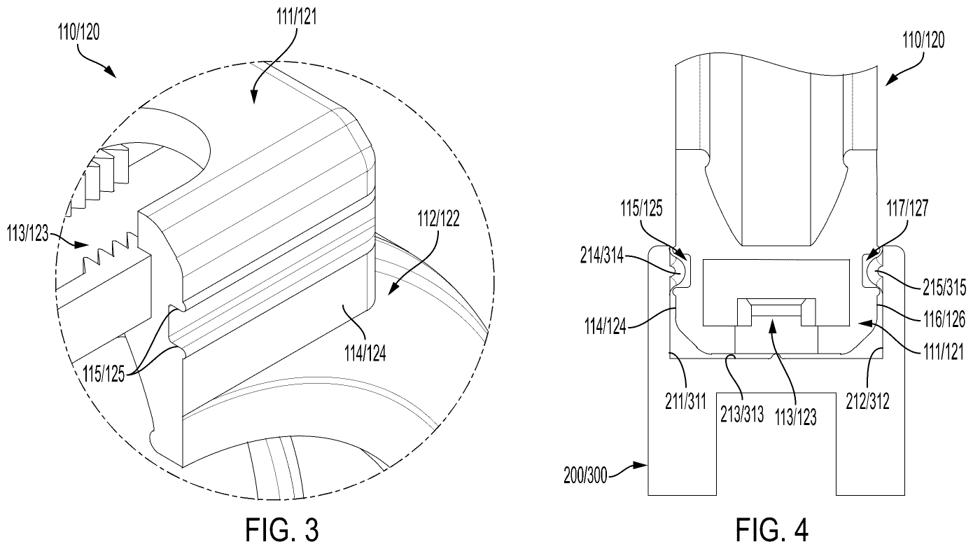

FIG. 2 also shows the first clamp sections (110) and the second clamp sections (120). As shown in FIG. 2, each first clamp section has a first protrusion (111) extending from a first sidewall ((112) as shown in FIG. 3) of a first engagement member ((113) as shown in FIG. 4). The first clamp sections are then arranged within the first magazine (200) with each first protrusion positioned within the first magazine channel (210).

Similarly, each second clamp section has a second protrusion (121) extending from a second sidewall ((122) as shown in FIG. 3) of a second engagement member ((123) as shown in FIG. 4). The second clamp sections are then arranged within the second magazine (300) with each second protrusion positioned within the second magazine channel (310).

The number of clamp sections included in the plurality of first clamp sections (110) and/or the plurality of second clamp sections (120) is not considered important and may vary depending upon the end user's needs. In general, the plurality of first clamp sections may comprise a number of first clamp sections in a range of between 2 and 100. Similarly, the plurality of second clamp sections may comprise a number of second clamp sections in a range of between 2 and 100.

While the clamp sections may take many forms, in preferred forms, each clamp section within an individual magazine may have a top surface (130A/130B) which conforms—in whole or in part—to the inner surface (140A/140B) of the other clamp sections within said individual magazine. In doing so, the clamp sections within an individual magazine may nest—in whole or in part—within one another to increase the number of clamp sections per linear distance that may be provided within each magazine.

One example of clamp sections which may be used in the system is a toothed clamp. In the toothed clamp, each clamp section includes a semi-circular wall with engagement members extending from opposing end points thereof. One of the engagement members of each clamp section takes the form of a tongue comprising a plurality of teeth configured to engage with a plurality of teeth formed within a channel of a protrusion of an engagement member of the opposing clamp section.

To assist with fitment and assembly, each magazine and each clamp section may optionally include additional features. One example of these features is shown in FIG. 3 and FIG. 4. As the magazines and clamp sections may be of similar or identical construction to one another, the embodiments shown in FIG. 3 and FIG. 4 may be considered to represent both the first magazine (200) and the second magazine (300) as well as both the first clamp section (110) and the second clamp section (120).

In the clamp section shown in FIG. 3 and FIG. 4, the protrusion (111/121) of the clamp section (110/120) comprises a protrusion first sidewall (114/124) having a groove (115/125), a protrusion second sidewall (116/126) having a groove (117/127), and a protrusion bottom wall as shown in FIG. 3. The magazine channel ((210/310) as shown in FIG. 2) comprises a channel first sidewall (211/311) having a tongue (214/314) extending therefrom, a second sidewall (212/312) having a tongue (215/315) extending therefrom, and a channel bottom wall (213/313).

As shown in FIG. 4, the tongue (214/314) of the channel first sidewall (211/311) is configured to engage the groove (115/125) of the protrusion first sidewall (114/124). Similarly, the tongue (215/315) of the channel second sidewall (212/312) is configured to engage the groove (117/127) of the protrusion second sidewall (116/126).

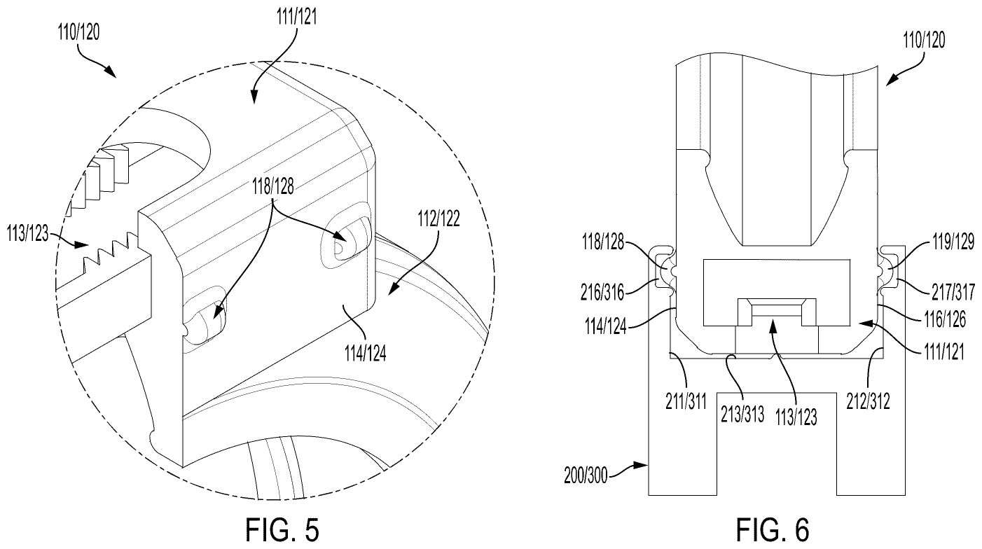

Another example of additional optional features to assist with fitment and assembly is shown in FIG. 5 and FIG. 6. As the magazines and clamp sections may be of similar or identical construction to one another, the magazine shown in FIG. 5 and FIG. 6 may be considered to represent both the first magazine (200) and the second magazine (300) as well as both the first clamp section (110) and the second clamp section (120).

In the clamp section shown in FIG. 5 and FIG. 6, the protrusion (111/121) of the clamp section (110/120) comprises a protrusion first sidewall (114/124) having a lip (118/128), a protrusion second sidewall (116/126) having a lip (119/129), and a protrusion bottom wall as shown in FIG. 5. The magazine channel ((210/310) as shown in FIG. 2) comprises a channel first sidewall (211/311) having a track (216/316), a second sidewall (212/312) having a track (217/317), and a channel bottom wall (213/313).

As shown in FIG. 6, the lip (118/128) of the protrusion first sidewall (114/124) is configured to engage the track (216/316) of the channel first sidewall (211/311). Similarly, the lip (119/129) of the protrusion second sidewall (116/126) is configured to engage the track (217/317) of the channel second sidewall (212/312).

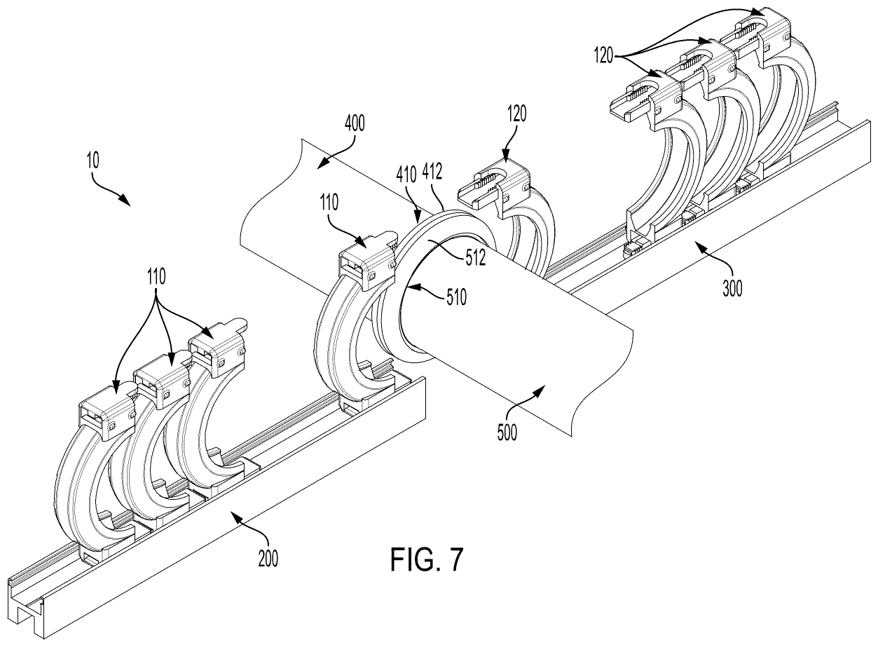

The system (10) disclosed herein may be used to quickly and securely connect two or more section of conduit to one another as shown in FIG. 7 through FIG. 9. To do so, one starts with at least two sections of conduit—referred to herein as a first conduit section (400) and a second conduit section (500). The first conduit section may include a first flange (412) at a first conduit section first end (410) which receives a second flange (512) at a second conduit section first end (510).

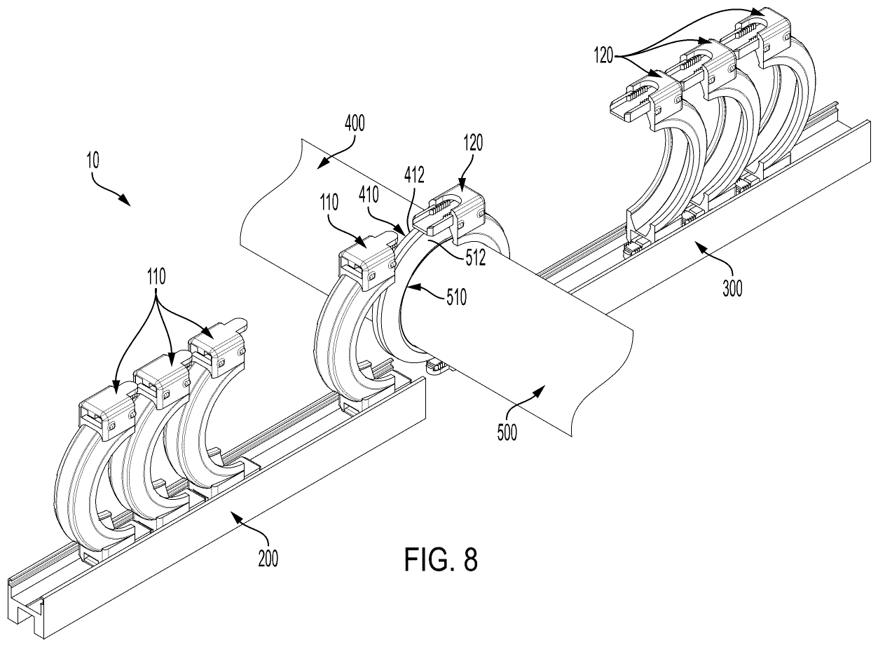

Once the first flange (412) is joined to the second flange (512), the first magazine (200) and the second magazine (300) are positioned on opposing sides of the joined flange assembly as shown in FIG. 7. One first clamp section (110) is then advanced laterally in the direction of the flange assembly until an inner wall of said first clamp section contacts the joined flange assembly as shown in FIG. 8. Subsequently—or simultaneously—one second clamp section (120) is advanced laterally in the direction of the flange assembly until engagement member(s) of the first clamp section contact corresponding engagement member(s) of the second clamp section. The first clamp section and the second clamp section are then further advanced in the direction of one another until a tight fit of the clamp (100) about the flange assembly is achieved as shown in FIG. 9.

This process can be repeated to join the second conduit section (500) to a third conduit section (not shown), the third conduit section to a fourth conduit section (not shown), and so on. To improve efficiency, the conduit sections may be adjoined to one another by advancing the conduit sections between the first magazine (200) and the second magazine (300) while the first magazine and the second magazine remain substantially stationary.

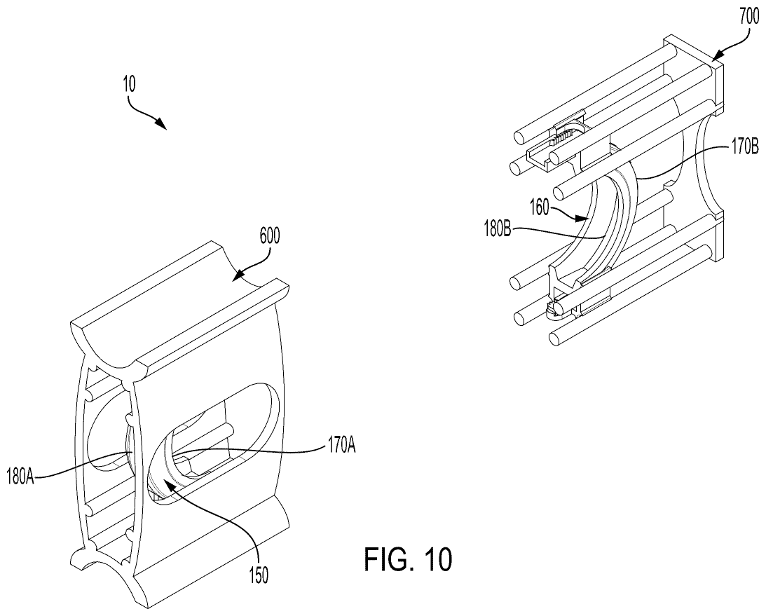

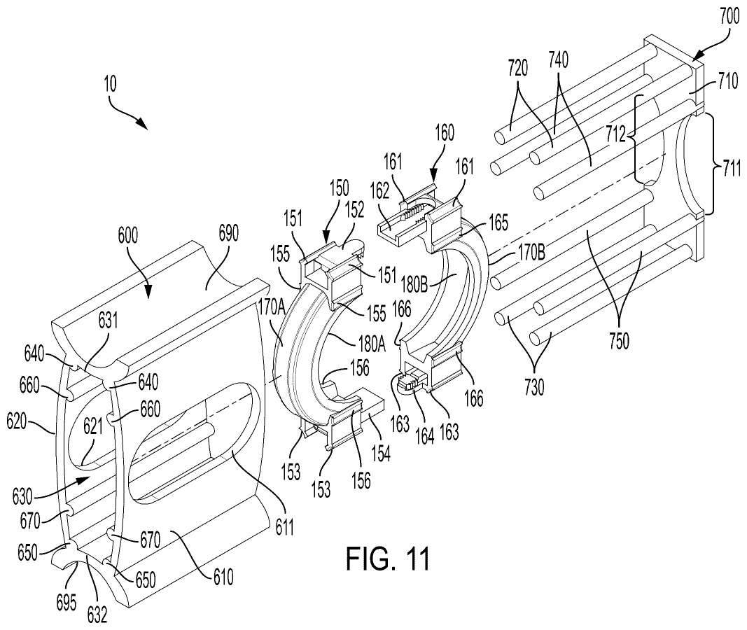

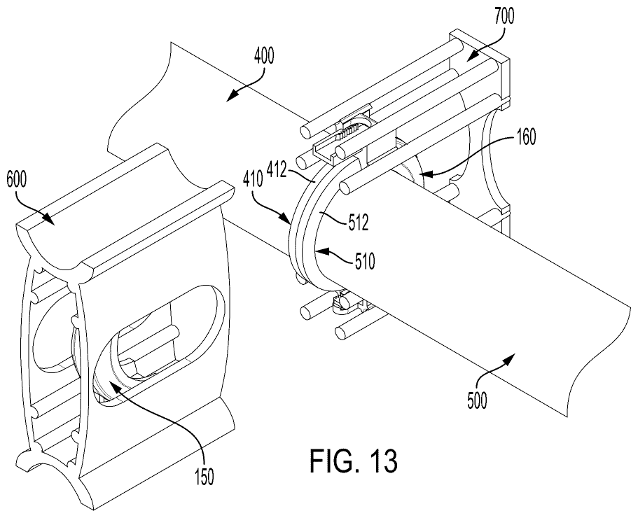

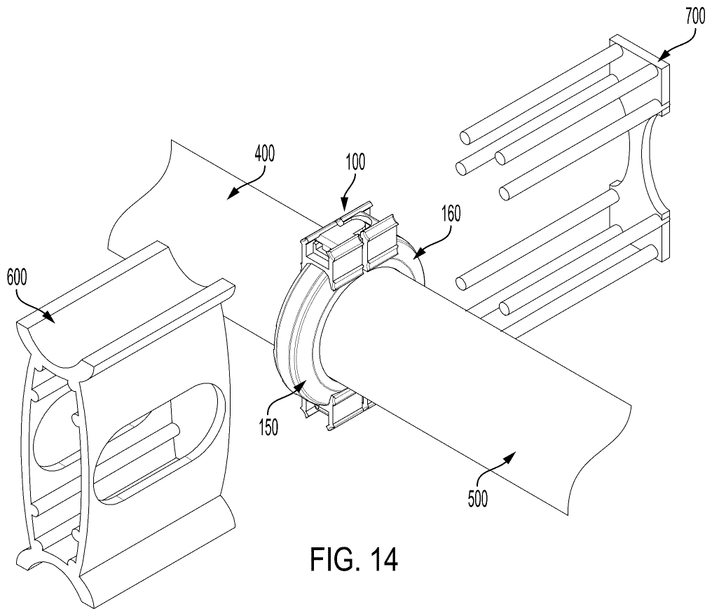

An alternative system for assembling a clamp is shown in FIG. 10 through FIG. 14. In this system, instead of utilizing the longitudinal magazines with channels running the length of the magazine as shown in FIG. 1 through FIG. 9, the system utilizes vertically oriented magazines. As shown in FIG. 10 and FIG. 11, this system (10) for assembling a clamp (100) includes a third magazine (600), a plurality of third clamp sections (150), a fourth magazine (700), and a plurality of fourth clamp sections (160).

The third magazine (600) may be considered a vertically oriented magazine as opposed to a longitudinal magazine such as those shown in FIG. 1 through FIG. 9. The third magazine includes at least a third magazine first sidewall (610) and a third magazine second sidewall (620) which form a third magazine hollow interior (630) within which the plurality of third clamp sections (150) reside prior to assembly. Optionally, the third magazine first sidewall may include a first access hole (611) and/or the third magazine second sidewall may include a second access hole (621) through which an instrument—such as a human finger or a screw driver blade—may be inserted to apply a force to one or more of the third clamp sections advancing said third clamp section(s) out of the third magazine hollow interior during assembly of the clamp (100). The third magazine hollow interior includes at least a first pair of guide members (640) at a first end (631) thereof and a second pair of guide members (650) at a second end (632) thereof.

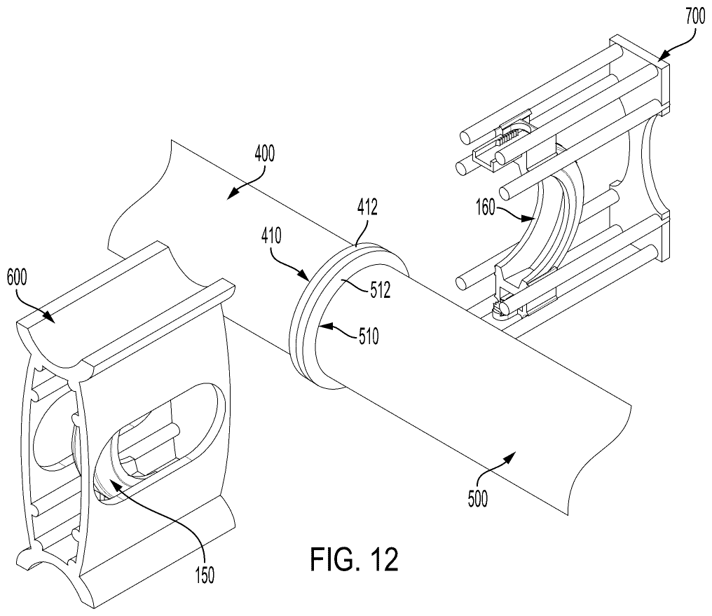

Each third clamp section of the plurality of third clamp sections (150) includes at least a first pair of receiver members (151) extending from a third engagement member (152) and a second pair of receiver members (153) extending from a fourth engagement member (154). When the third clamp sections are disposed within the third magazine hollow interior (630) prior to assembly, the first pair of guide members (640) engage with the first pair of receiver members while the second pair of guide members (650) engage with the second pair of receiver members to maintain the plurality of third clamp sections within the third magazine hollow interior until acted upon by an outside force during assembly of the clamp (100). Preferably, these engagements will be slideable allowing an outside force, such as that provided by a human hand or by a mechanical device such as a linear actuator, to advance a third clamp section along the pairs of guide members until they exit the third magazine hollow interior to be assembled with a fourth clamp section as described herein and shown in FIG. 12 to FIG. 14. One example of a linear actuator is a Micro Pen Actuator with Feedback available from Firgelli Automations of Ferndale, Washington, U.S.A.

Optionally, the third magazine (600) may include a fifth pair of guide members (660). When present, the fifth pair of guide members will be located between the first pair of guide members (640) and the second pair of guide members (650) adjacent to the first pair of guide members as shown in FIG. 10 and FIG. 11. In these embodiments, each third clamp section of the plurality of third clamp sections (150) may include a fifth pair of receiver members (155) extending from the third engagement member (152) between the first pair of receiver members (151) and the second pair of receiver members (153). When the third clamp sections are disposed within the third magazine hollow interior (630) prior to assembly, the fifth pair of guide members engage with the fifth pair of receiver members to assist in maintaining the plurality of third clamp sections within the third magazine hollow interior until acted upon by an outside force during assembly of the clamp (100). Preferably, this engagement will be slideable allowing an outside force, such as that provided by a human hand or by a mechanical device such as a linear actuator, to advance a third clamp section along the pairs of guide members until they exit the third magazine hollow interior to be assembled with a fourth clamp section as described herein and shown in FIG. 12 to FIG. 14. One example of a linear actuator is a Micro Pen Actuator with Feedback available from Firgelli Automations of Ferndale, Washington, U.S.A.

Also optionally, the third magazine (600) may include a sixth pair of guide members (670). When present, the sixth pair of guide members will be located between the second pair of guide members (650) and the first pair of guide members (640) adjacent to the second pair of guide members as shown in FIG. 10 and FIG. 11. In these embodiments, each third clamp section of the plurality of third clamp sections (150) may include a sixth pair of receiver members (156) extending from the fourth engagement member (154) between the second pair of receiver members (153) and the first pair of receiver members (151). When the third clamp sections are disposed within the third magazine hollow interior (630) prior to assembly, the sixth pair of guide members engage with the sixth pair of receiver members to assist in maintaining the plurality of third clamp sections within the third magazine hollow interior until acted upon by an outside force during assembly of the clamp (100). Preferably, this engagement will be slideable allowing an outside force, such as that provided by a human hand or by a mechanical device such as a linear actuator, to advance a third clamp section along the pairs of guide members until they exit the third magazine hollow interior to be assembled with a fourth clamp section as described herein and shown in FIG. 12 to FIG. 14. One example of a linear actuator is a Micro Pen Actuator with Feedback available from Firgelli Automations of Ferndale, Washington, U.S.A.

The pairs of guide members for the third magazine—including the first pair of guide members (640), the second pair of guide members (650), the fifth pair of guide members (660), and/or the sixth pair of guide members (670)—may have a number of different shapes. While FIG. 10 through FIG. 14 shows the pairs of guide members having a substantially cylindrical shape configured to engage with pairs of receiver members having an arched profile, other shapes may exist. For example, in some embodiments, the pairs of guide members may have a substantially cuboid shape configured to engage with pairs of receiver members having an angled profile.

While the third magazine (600) has at least two sidewalls (610 and 620), other embodiments exist. For instance, the third magazine may include a third magazine third sidewall (690) and a third magazine fourth sidewall (695) forming a substantially rectangular profile. The third magazine third sidewall, when present, may span a distance between the third magazine first sidewall and the third magazine second sidewall at the first end of the third magazine hollow interior (630). When present, the third magazine fourth sidewall may span a distance between the third magazine first sidewall and the third magazine second sidewall at the second end of the third magazine hollow interior.

The fourth magazine (700) may also be considered a vertically oriented magazine as opposed to a longitudinal magazine such as those shown in FIG. 1 through FIG. 9. The fourth magazine includes a fourth magazine back wall (710). Attached to and extending from the fourth magazine back wall is at least a third pair of guide members (720) at a third end thereof and a fourth pair of guide members (730) at a fourth end thereof.

Each fourth clamp section of the plurality of fourth clamp sections (160) includes at least a third pair of receiver members (161) extending from a fifth engagement member (162) and a fourth pair of receiver members (163) extending from a sixth engagement member (164). When the fourth clamp sections are disposed within the fourth magazine (700) prior to assembly, the third pair of guide members (720) engage with the third pair of receiver members while the fourth pair of guide members (730) engage with the fourth pair of receiver members to maintain the plurality of fourth clamp sections within the fourth magazine until acted upon by an outside force during assembly of the clamp (100). Preferably, these engagements will be slideable allowing an outside force, such as that provided by a human hand or by a mechanical device such as a linear actuator, to advance a fourth clamp section along the pairs of guide members until they exit the fourth magazine to be assembled with a third clamp section as described herein and shown in FIG. 12 to FIG. 14. One example of a linear actuator is a Micro Pen Actuator with Feedback available from Firgelli Automations of Ferndale, Washington, U.S.A.

Optionally, the fourth magazine (700) may include a seventh pair of guide members (740) attached to and extending from the fourth magazine back wall (710). When present, the seventh pair of guide members will be located between the third pair of guide members (720) and the fourth pair of guide members (730) adjacent to the third pair of guide members as shown in FIG. 10 and FIG. 11. In these embodiments, each fourth clamp section of the plurality of fourth clamp sections (160) may include a seventh pair of receiver members (165) extending from the fifth engagement member (162) between the third pair of receiver members (161) and the fourth pair of receiver members (163). When the fourth clamp sections are disposed within the fourth magazine prior to assembly, the seventh pair of guide members engage with the seventh pair of receiver members to assist in maintaining the plurality of fourth clamp sections within the fourth magazine until acted upon by an outside force during assembly of the clamp (100). Preferably, this engagement will be slideable allowing an outside force, such as that provided by a human hand or by a mechanical device such as a linear actuator, to advance a fourth clamp section along the pairs of guide members until they exit the fourth magazine to be assembled with a third clamp section as described herein and shown in FIG. 12 to FIG. 14. One example of a linear actuator is a Micro Pen Actuator with Feedback available from Firgelli Automations of Ferndale, Washington, U.S.A.

Also optionally, the fourth magazine (700) may include an eighth pair of guide members (750) attached to and extending from the fourth magazine back wall (710). When present, the eighth pair of guide members will be located between the fourth pair of guide members (730) and the third pair of guide members (720) adjacent to the fourth pair of guide members as shown in FIG. 10 and FIG. 11. In these embodiments, each fourth clamp section of the plurality of fourth clamp sections (160) may include an eighth pair of receiver members (166) extending from the sixth engagement member (164) between the fourth pair of receiver members (163) and the third pair of receiver members (161). When the fourth clamp sections are disposed within the fourth magazine prior to assembly, the eighth pair of guide members engage with the eighth pair of receiver members to assist in maintaining the plurality of fourth clamp sections within the fourth magazine until acted upon by an outside force during assembly of the clamp (100). Preferably, this engagement will be slideable allowing an outside force, such as that provided by a human hand or by a mechanical device such as a linear actuator, to advance a fourth clamp section along the pairs of guide members until they exit the fourth magazine to be assembled with a third clamp section as described herein and shown in FIG. 12 to FIG. 14. One example of a linear actuator is a Micro Pen Actuator with Feedback available from Firgelli Automations of Ferndale, Washington, U.S.A.

The pairs of guide members of the fourth magazine—including the third pair of guide members (720), the fourth pair of guide members (730), the seventh pair of guide members (740), and/or the eighth pair of guide members (750)—may have a number of different shapes. While FIG. 10 through FIG. 14 shows the pairs of guide members having a substantially cylindrical shape configured to engage with pairs of receiver members having an arched profile, other shapes may exist. For example, in some embodiments, the pairs of guide members may have a substantially cuboid shape configured to engage with pairs of receiver members having an angled profile.

The number of clamp sections included in the plurality of third clamp sections (150) and/or the plurality of fourth clamp sections (160) is not considered important and may vary depending upon the end user's needs. In general, the plurality of third clamp sections may comprise a number of third clamp sections in a range of between 2 and 100. Similarly, the plurality of fourth clamp sections may comprise a number of fourth clamp sections in a range of between 2 and 100.

While the clamp sections may take many forms, in preferred forms, each clamp section within an individual magazine may have a top surface (170A/170B) which conforms—in whole or in part—to the inner surface (180A/180B) of the other clamp sections within said individual magazine. In doing so, the clamp sections within an individual magazine may nest—in whole or in part—within one another to increase the number of clamp sections per linear distance that may be provided within each magazine.

One example of clamp sections which may be used in the system is a toothed clamp. In the toothed clamp, each clamp section includes a semi-circular wall with engagement members extending from opposing end points thereof. One of the engagement members of each clamp section takes the form of a tongue comprising a plurality of teeth configured to engage with a plurality of teeth formed within a channel of a protrusion of an engagement member of the opposing clamp section.

The components of the clamp sections and the magazines disclosed herein—including the first clamp section (110), the second clamp section (120), the third clamp section (150), the fourth clamp section (160), the first magazine (200), the second magazine (300), the third magazine (600), and/or the fourth magazine (700) —may be fabricated of any number of materials utilizing any number of manufacturing techniques. Non-limiting examples of such materials include polymeric materials. Non-limiting examples of such manufacturing techniques include injection molding and additive manufacturing (also known as 3D printing).

The systems described herein utilizing a pair of magazines—each comprising a plurality of clamp sections—allows for assemblers to quickly and easily assemble a series of clamps for a single-use aseptic chemical manufacturing system. By keeping the magazines relatively stationary and advancing the conduit section(s) between the first magazine and the second magazine until a joint in the conduit is reached, followed by assembling two opposing clamp sections from the two opposing magazines around said joint, a series of joints can be clamped together in quick succession by a single user. The systems described herein prevents the time-consuming process of the user having to find, align, and assemble each individual joint by hand as the assembler moves along a section of conduit. The systems described herein also allow for efficient packaging, shipment, and storage of a plurality of clamp sections with the various clamp sections contained within their respective magazine's during shipment and storage.

While the systems described herein may allow for the clamps to be assembled by hand, it is also contemplated that one or more of the clamps may be assembled by a mechanical device such as a linear actuator. Such mechanical device would be assembled in conjunction with at least one—preferably both—of the magazines to apply a pre-defined amount of force to the clamp section(s) to discharge the clamp section(s) from the magazine. In doing so, the mechanical devices apply a consistent and repeatable amount of force about the joints in the conduit section(s). The amount of force equivalent to an amount of torque which may be in a range of between 5 inch pounds and 50 inch pounds.

While the engagement members shown in the drawings are straight and not curved or flexible, a curved—and/or flexible—engagement member system towards the opposite clamp section is also conceived. In this embodiment, curving the engagement member increases the amount of tightness as the force required to move the engagement member increases by the force required to navigate the curve. Additionally, the curved engagement member would also allow for a smaller side profile as the square extensions from the clamp could be eliminated as the engagement member curves around with the clamp.

While the systems have been described as having one or more exemplary designs, the present systems may be further modified within the spirit and scope of this disclosure. This application is therefore intended to cover any variations, uses, or adaptations of the systems using their general principles.

What is claimed is:

1. A system (10) for assembling a clamp (100), said system comprising:
a first magazine (200) comprising a first magazine channel (210) spanning at least a portion of a first length (220) of the first magazine;
a plurality of first clamp sections (110), each first clamp section having a first protrusion (111) extending from a first sidewall (112) of a first engagement member (113);
a second magazine (300) comprising a second magazine channel (310) spanning at least a portion of a second length (320) of the second magazine; and
a plurality of second clamp sections (120), each second clamp section having a second protrusion (121) extending from a second sidewall (122) of a second engagement member (123); and
wherein the first clamp sections are arranged within the first magazine with each first protrusion positioned within the first magazine channel; and the second clamp sections are arranged within the second magazine with each second protrusion positioned within the second magazine channel.

2. The system of claim 1,
the first magazine channel comprising a first channel first sidewall (211) having a first tongue (214) extending therefrom, a first channel second sidewall (212) having a second tongue (215) extending therefrom, and a first channel bottom wall (213); and
the first protrusion comprising a first protrusion first sidewall (114) having a first groove (115), a first protrusion second sidewall (116) having a second groove (117), and a first protrusion bottom wall; and
wherein the first tongue is configured to engage the first groove, and the second tongue is configured to engage the second groove.

3. The system of claim 1,
the first magazine channel comprising a first channel first sidewall (211) having a first track (216), a first channel second sidewall (212) having a second track (217), and a first channel bottom wall (213); and
the first protrusion comprising a first protrusion first sidewall (114) having a first lip (118), a first protrusion second sidewall (116) having a second lip (119), and a first protrusion bottom wall; and
wherein the first lip is configured to engage the first track, and the second lip is configured to engage the second track.

4. The system of claim 1,
the second magazine channel comprising a second channel first sidewall (311) having a third tongue (314) extending therefrom, a second channel second sidewall (312) having a fourth tongue (315) extending therefrom, and a second channel bottom wall (313); and
the second protrusion comprising a second protrusion first sidewall (124) having a third groove (125), a second protrusion second sidewall (126) having a fourth groove (127), and a second protrusion bottom wall; and
wherein the third tongue is configured to engage the third groove, and the fourth tongue is configured to engage the fourth groove.

5. The system of claim 1,
the second magazine channel comprising a second channel first sidewall (311) having a third track (316), a second channel second sidewall (312) having a fourth track (317), and a second channel bottom wall (313); and
the second protrusion comprising a second protrusion first sidewall (124) having a third lip (128), a second protrusion second sidewall (126) having a fourth lip (129), and a second protrusion bottom wall; and
wherein the third lip is configured to engage the third track, and the fourth lip is configured to engage the fourth track.

6. The system of claim 1, wherein each first clamp section and each second clamp section is a toothed clamp sections.

7. The system of claim 1, wherein the plurality of first clamp sections comprises a number of first clamp sections in a range of between 2 and 100, and the plurality of second clamp sections comprises a number of second clamp sections in a range of between 2 and 100.

8. The system of claim 1, wherein each first clamp section of the plurality of first clamp sections comprises a first top surface (130A) which at least partially conforms to a first inner surface (140A) of each other first clamp section of the plurality of first clamp sections, and at least one of the first clamp sections of the plurality of first clamp sections is at least partially nested within another first clamp section of the plurality of first clamp sections.

9. The system of claim 1, wherein each second clamp section of the plurality of second clamp sections comprises a second top surface (130B) which at least partially conforms to a second inner surface (140B) of each other second clamp section of the plurality of second clamp sections, and at least one of the second clamp sections of the plurality of second clamp sections is at least partially nested within another second clamp section of the plurality of second clamp sections.

10. A system (10) for assembling a clamp (100), said system comprising:
a third magazine (600) comprising at least a third magazine first sidewall (610) and a third magazine second sidewall (620) forming a third magazine hollow interior (630) comprising at least a first pair of guide members (640) at a first end (631) of the third magazine hollow interior and a second pair of guide members (650) at a second end (632) of the third magazine hollow interior;
a plurality of third clamp sections (150), each third clamp section having at least a first pair of receiver members (151) extending from a third engagement member (152) and a second pair of receiver members (153) extending from a fourth engagement member (154);
a fourth magazine (700) comprising a fourth magazine back wall (710) having at least a third pair of guide members (720) extending from a third end of the third magazine back wall and a fourth pair of guide members (730) extending from a fourth end of the fourth magazine back wall; and
a plurality of fourth clamp sections (160), each fourth clamp section having at least a third pair of receiver members (161) extending from a fifth engagement member (162) and a fourth pair of receiver members (163) extending from a sixth engagement member (164); and
wherein the third clamp sections are arranged within the third magazine with the first pair of guide members engaged with the first pair of receiver members and the second pair of guide members engaged with the second pair of receiver members; and the fourth clamp sections are arranged within the fourth magazine with the third pair of guide members engaged with the third pair of receiver members and the fourth pair of guide members engaged with the fourth pair of receiver members.

11. The system for assembling a clamp of claim 10, wherein
the third magazine comprises a fifth pair of guide members (660) between the first pair of guide members and the second pair of guide members; and
each third clamp section comprises a fifth pair of receiver members (155) extending from the third engagement member between the first pair of receiver members and the second pair of receiver members; and
wherein the fifth pair of guide members are engaged with the fifth pair of receiver members.

12. The system for assembling a clamp of claim 10, wherein
the third magazine comprises a sixth pair of guide members (670) between the second pair of guide members and the first pair of guide members; and
each third clamp section comprises a sixth pair of receiver members (156) extending from the fourth engagement member between the second pair of receiver members and the first pair of receiver members; and
wherein the sixth pair of guide members are engaged with the sixth pair of receiver members.

13. The system for assembling a clamp of claim 10, wherein
the fourth magazine comprises a seventh pair of guide members (740) between the third pair of guide members and the fourth pair of guide members; and
each fourth clamp section comprises a seventh pair of receiver members (165) extending from the fifth engagement member between the third pair of receiver members and the fourth pair of receiver members; and
wherein the seventh pair of guide members are engaged with the seventh pair of receiver members.

14. The system for assembling a clamp of claim 10, wherein
the fourth magazine comprises an eighth pair of guide members (750) between the fourth pair of guide members and the third pair of guide members; and
each fourth clamp section comprises an eighth pair of receiver members (166) extending from the sixth engagement member between the fourth pair of receiver members and the third pair of receiver members; and
wherein the eighth pair of guide members are engaged with the eighth pair of receiver members.

15. The system for assembling a clamp of claim 10, wherein the third magazine first sidewall comprises a first access hole (611), and the third magazine second sidewall comprises a second access hole (621).

16. The system for assembling a clamp of claim 10, wherein the fourth magazine back wall comprises a first indentation (711), and the fourth magazine back wall comprises a second indentation (712).

17. The system of claim 10, wherein each third clamp section and each fourth clamp section is a toothed clamp sections.

18. The system of claim 10, wherein the plurality of third clamp sections comprises a number of third clamp sections in a range of between 2 and 100, and the plurality of fourth clamp sections comprises a number of fourth clamp sections in a range of between 2 and 100.

19. The system of claim 10, wherein each third clamp section of the plurality of third clamp sections comprises a third top surface (170A) which at least partially conforms to a third inner surface (180A) of each other third clamp section of the plurality of third clamp sections, and at least one of the third clamp sections of the plurality of third clamp sections is at least partially nested within another third clamp section of the plurality of third clamp sections.

20. The system of claim 10, wherein each fourth clamp section of the plurality of fourth clamp sections comprises a fourth top surface (170B) which at least partially conforms to a fourth inner surface (180B) of each other fourth clamp section of the plurality of fourth clamp sections, and at least one of the fourth clamp sections of the plurality of fourth clamp sections is at least partially nested within another fourth clamp section of the plurality of fourth clamp sections.
